(19) United States
(12) Patent Application Publication
(10) Pub. No.: US 2009/0061171 A1
(43) Pub. Date: Mar. 5, 2009

(54) SUBSTRATES COATED WITH BRANCHED POLYURETHANES FOR ELECTROPHOTOGRAPHIC PRINTING PROCESSES

(75) Inventors: Hildegard Stein, Mannheim (DE); Roland Ettl, Ketsch (DE); Bernd Bruchmann, Freinsheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, LUDWIGSHAFEN (DE)

(21) Appl. No.: 12/282,516

(22) PCT Filed: Mar. 13, 2007
(86) PCT No.: PCT/EP07/52334

§ 371 Date: Sep. 11, 2008

(30) Foreign Application Priority Data
Mar. 22, 2006 (EP) 06111522.6

(51) Int. Cl. B32B 3/00; B05D 5/00

(52) U.S. Cl. 428/195.1; 427/256

(57) ABSTRACT

Process for printing on substrates, wherein the substrates are pre-treated with a composition which comprises a polyurethane, polyureaurethane or polyurea or a mixture thereof.

The invention relates to a process for printing on substrates, wherein the substrates are pre-treated with a composition which comprises a polyurethane, polyureaurethane or polyurea or a mixture thereof.

An important feature of electrophotographic printing processes is that electrostatically charged dye systems, so-called toners, are used and an electrostatic charge image which can be developed in various ways is produced.

In the electrophotographic printing process, two physically different toner systems are used: dry toner (i.e. toner which is present in solid form at room temperature and becomes liquid only under the action of heat at relatively high temperatures of about 130° C.) and liquid toner (toner which has a very low melting point).

Electrostatic printing processes using a liquid toner are also referred to as LEP (liquid electrostatic printing) or indigo printing processes.

Owing to the low melting point and the low fixing temperature of the toner on the paper (in general from 40 to 100° C.), the toner adhesion to paper is frequently insufficient in the LEP process.

WO 96/06384 describes the improvement of the adhesion of the liquid toner to paper substrates by treatment of the surface with substances which carry a basic functionality, polyethylenimines (PEI, e.g. Polymin P), ethoxylated PEIs, epichlorohydrins-polyethylenimines and polyamides being mentioned exclusively as being preferred. A decisive disadvantage of this method of treatment, however, is the loss of whiteness and the yellowing of the paper on prolonged storage.

U.S. Pat. No. 5,281,507 describes the use of (partly) fluorinated hydrocarbons or surfactants on the substrate surface for improving the printed image and the toner adhesion.

In EP 0879917, mixtures of salts (e.g. aluminate salts or salts of a weak acid and of a strong base) are used in order to impart to the paper surface an alkaline pH, which in turn results in improved printability by means of liquid toners.

WO 2004/092483 describes the surface treatment of paper with a combination of starch, an acrylic acid polymer and a further organic compound, e.g. a polyglyceryl ester. The use of the polyglyceryl ester is regarded as essential for achieving good toner fixing.

EP 1 026 185 describes a process for the preparation of dendritic or highly branched polyurethanes by reacting diisocyanates with compounds having at least two groups reactive with isocyanates, different reactivities of the functional groups being required and being utilized in the synthesis of the polymers. The highly branched or dendritic polyurethanes obtained are recommended, for example, for use as compatiblizers, rheology assistants or catalyst supports.

WO 02/36695 describes the use of hyperbranched polyurethanes for the production of printing inks and printing varnishes.

DE-A 102 49 841 discloses the use of dendritic polyurethanes for modifying and functionalizing surfaces; for example, the surface of textiles can be rendered hydrophilic or hydrophobic in this manner. There is no mention of printable substrates or of printing on substrates.

It was an object of the present invention to improve the electrostatic printing processes, in particular the LEP process. It was also an object to provide suitable substrates for such printing processes. By measures which are as simple as possible, it was intended, in particular to permit as good fixing as possible of the liquid toner on different paper qualities.

Accordingly, the process defined above was found.

An important feature of the invention is the use of a composition which comprises a polyurethane, polyureaurethane or polyurea for the pretreatment of the substrates to be printed on.

### Regarding the Composition

In the context of this invention, the term “polyurethanes, polyureaurethanes or polyureas” comprises very generally those polymers which are obtainable by reacting at least one di- and/or polyisocyanate with at least one compound which has at least one group reactive toward isocyanate groups. These include prepolymers whose repeating units are also linked by urea, allophanate, biuret, carbodiimide, amide, uretonimine, uretdione, isocyanurate or oxazolidone (oxazolidinone) groups in addition to urethane groups (cf. for example Kunststofftaschenbuch, Saechtling, 26th edition, page 491 et seq., Carl-Hanser-Verlag, Munich 1995). The term “polyurethanes” comprises in particular polymers which comprise predominantly urethane groups as repeating units; the term polyurea comprises polymers which have predominantly urea groups as repeating units.

Polyurethanes, polyureaurethanes or polyureas which have a weight average molecular weight in the range of from about 500 to 100 000, preferably from 1000 to 50 000, are preferred.

The content of urethane and/or urea groups (and, if present, further groups obtained by reaction of an isocyanate group with a group reactive therewith and having an active hydrogen atom) is preferably in the range of from 0.5 to 10 mol/kg, particularly preferably from 1 to 10 mol/kg, in particular from 2 to 8 mol/kg of polymer.

Polyurethanes, in particular polyurethanes having the above content of urethane groups, are particularly preferred.

In particular, at least partially branched polyurethane, polyureaurethane or polyurea, particularly preferably an at least partly branched polyurethane, is present.

Branched polyurethanes are obtainable by the concomitant use of at least trifunctional compounds, i.e. compounds having at least three isocyanate groups or at least three groups reactive toward isocyanate or compounds having isocyanate groups and reactive groups, the sum of the two being at least three; the latter are generally prepared using protective groups.

The polyurethane, polyureaurethane or polyurea used according to the invention is obtainable in particular by reaction of isocyanate groups, urethane groups, urea groups or carbonate groups (referred to below as group) with functional groups which are reactive with the respective groups (referred to below as “reactive groups” for short), the compounds used in the reaction being selected from those which comprise only groups (compound A), those which comprise only reactive groups (compound B) or those which comprise groups and reactive groups (compound C) and at least 1 mol %, preferably at least 5 mol %, particularly preferably at least 10 mol % and very particularly preferably at least 15 mol % of the sum of groups and reactive groups are a constituent of at least trifunctional compounds A), B) or C).

Highly branched polyurethanes, polyureaurethanes or polyureas are very particularly preferred; particularly highly branched polyurethanes, polyureaurethanes or polyureas having a regular structure are also referred to as dendritic polyurethanes. Dendritic polymers in turn are subdivided into hyperbranched or dendrimeric polyurethanes, polyureaurethanes or polyureas.

In the context of the present invention, the term “hyperbranched polymers” comprises very generally polymers which are distinguished by a branched structure and a high functionality. Regarding the general definition of hyperbranched polymers, reference is also made to P. J. Flory, J. Am. Chem. Soc. 1952, 74, 2718, and H. Frey et al., Chem. Eur. J. 2000, 6, No. 14, 2499. The hyperbranched polymers used according to the invention preferably have at least four further functional groups in addition to urethane and/or urea groups (or further groups originating from the reaction of isocyanate groups). The proportion of functional groups is on average from 4 to 100, particularly preferably from 5 to 30 and in particular from 6 to 20 per molecule.

“Dendrimeric” (cascade polymers, arborols, isotropically branched polymers, isobranched polymers, starburst polymers) are molecularly uniform macromolecules having a highly symmetrical structure. Dendrimers are structurally derived from the star polymers, the individual chains in turn being branched in each case in a star-like manner. They form starting from small molecules by a constantly repeating reaction sequence, resulting in an increasing number of branches, at the ends of which functional groups which in turn are a starting point for further branches are present in each case. Thus, the number of monomer terminal groups grows exponentially with each reaction step, the spherical tree structure finally resulting. A characteristic feature of the dendrimers is the number of reaction stages (generations) carried out for their synthesis. Because of their uniform structure, dendrimers have, as a rule, a defined molar mass.

In the context of the invention, the “hyperbranched polymers” also include star polymers and comb polymers.

“Star polymers” are polymers in which three or more chains emanate from a center. The center may be an individual atom or a group of atoms. “Comb polymers” are polymers which have comb-like branches emanating from a linear polymer backbone.

Both molecularly uniform and structurally uniform “hyperbranched polymers” which have side chains of different length and branching and a molar mass distribution are furthermore suitable.

The so-called ABx monomers are particularly suitable for the synthesis of these hyperbranched polymers. Said monomers have two different functional groups A and B which can react with one another with formation of a link. The functional group A is present only once per molecule and the functional group B twice or more. As a result of the reaction of said ABx monomers with one another, crosslinked polymers having regularly arranged branching points form. The polymers have virtually exclusively B groups at the chain ends. Further details are to be found, for example, in Journal of Molecular Science, Rev. Macromol. Chem. Phys., C37(3), 555-579 (1997).

Hyperbranched polymers suitable according to the invention are described in WO 97/02304, U.S. Pat. No. 5,936,055, DE-A 100 13 187, DE-A 100 30 869, DE-A 199 04 444, DE-A 103 22 401, US 2002/161113, WO 03/066702, WO 2005/044897 and WO 2005/075541, which are hereby incorporated by reference.

The dendritic polymers used according to the invention preferably have a degree of branching (DB), corresponding to the sum of the average number of dendritic links and terminal units divided by the sum of the average number of total links (dendritic, linear and terminal links) multiplied by 100, of from 10 to 100%, preferably from 10 to 90% and in particular from 10 to 80%. Regarding the definition of “degree of branching”, reference is made to H. Frey et al., Acta Polym. 1997, 48, 30.

Hyperbranched polymers, i.e. molecularly uniform and structurally uniform polymers, are preferably used. These are as a rule simpler and therefore more economical to prepare than dendrimers. In order to achieve an advantageous surface modification, however, structurally uniform and molecularly uniform dendrimeric polymers and star polymers can of course also be used.

The synthesis of hyperbranched polyurethanes and polyureas which can be used according to the invention can be effected, for example, as described below.

For the synthesis of the hyperbranched polyurethanes and polyureas, it is preferable to use ABx monomers which have both isocyanate, urethane, urea or carbonate groups and groups which can react with these groups with formation of a link. x is a natural number from 2 to 8. x is preferably 2 or 3. Either A comprises the isocyanate, urethane, urea or carbonate groups and B comprises groups reactive with these or the converse case may occur.

The groups reactive with isocyanate, urethane, urea or carbonate groups are preferably OH, NH₂, NH, SH or COOH groups.

The ABx monomers can be prepared in a known manner by means of various techniques.

ABx monomers can be synthesized, for example, according to the methods disclosed in WO 97/02304, with the use of protective group techniques. For example, this technique is explained for the preparation of an AB2 monomer from 2,4-toluylene diisocyanate (TDI) and trimethylolpropane. First one of the isocyanate groups of the TDI is blocked in a known manner, for example by reaction with an oxime. The remaining free NCO group is reacted with trimethylolpropane, on average one of the three OH groups reacting with the isocyanate group. After elimination of the protective group, a molecule having an isocyanate group and 2 OH groups is obtained.

The ABx molecules can particularly advantageously be synthesized by the method which is disclosed in DE-A 199 04 444 and in which no protective groups are required. In this method, di- or polyisocyanates are used and are reacted with compounds which have at least two groups reactive with isocyanate groups. At least one of the reactants has groups having a reactivity differing from that of the other reactant. Preferably, both reactants have groups having a reactivity differing from that of the other reactant. The reaction conditions are chosen so that only certain reactive groups can react with one another. The reaction of hexamethylene diisocyanate with diethanolamine may be described here by way of example. In the case of diethanolamine, the amino group has a substantially higher reactivity with respect to isocyanate groups than the two hydroxyl groups. This difference in reactivity is utilized for synthesizing a hyperbranched polyureaurethane specifically via urethane and urea structures.

Furthermore, ABx molecules can be prepared as described in WO 03/066702. Here, isocyanate groups protected by blocking agents are reacted with polyamines to give polyureas. The polyureas can also be synthesized via the reaction of polyamines with dialkyl or diaryl carbonates according to WO 2005/044897 or via the reaction of polyamines with ureas according to WO 2005/075541.

Suitable di- or polyisocyanates are the aliphatic, cycloaliphatic, araliphatic and aromatic di- or polyisocyanates known in the prior art and mentioned by way of example below. Diphenylmethane 4,4′-diisocyanate, the mixtures of monomeric diphenylmethane diisocyanates and oligomeric diphenylmethane diisocyanates (polymer MDI), tetramethylene diisocyanate, tetramethylene diisocyanate trimers, hexamethylene diisocyanate, hexamethylene diisocyanate trimers, isophorone diisocyanate trimer, methylenebis(cyclohexyl) 4,4′-diisocyanate, xylylene diisocyanate, tetramethylxylylene diisocyanate, dodecyl diisocyanate, lysine alkyl ester diisocyanate, where alkyl is C1-C10, 1,4-diisocyanatocyclohexane or 4-isocyanatomethyl-1,8-octamethylene diisocyanate may preferably be mentioned here.

Di- or polyisocyanates which have NCO groups of different reactivity are particularly preferably suitable for the synthesis of the polyurethanes, polyureaurethanes and polyureas. Toluylene 2,4-diisocyanate (2,4-TDI), diphenylmethane 2,4′-diisocyanate (2,4′MDI), triisocyanatotoluene, isophorone diisocyanate (IPDI), 2-butyl-2-ethylpentamethylene diisocyanate, 2,2,4- or 2,4,4-trimethyl-1,6-hexamethylene diisocyanate, 2-isocyanatopropylcyclohexyl isocyanate, 3(4)-isocyanatomethyl-1-methylcyclohexyl isocyanate, 1,4-diisocyanato-4-methylpentane, methylenebis(cyclohexyl) 2,4′-diisocyanate and 4-methylcyclohexane 1,3-diisocyanate (H-TDI) may be mentioned here.

Isocyanates whose NCO groups initially have the same reactivity but in which a decrease in reactivity in the case of the second NCO group can be induced by initial addition of a reactant at an NCO group are furthermore suitable for the synthesis of the polyurethanes, polyureaurethanes and polyureas. Examples of this are isocyanates whose NCO groups are coupled by a delocalized π electron system, e.g. phenylene 1,3- and 1,4-diisocyanate, naphthylene 1,5-diisocyanate, biphenyl diisocyanate, tolidine diisocyanate or toluylene 2,6-diisocyanate.

For example, oligo- or polyisocyanates which can be prepared from the abovementioned di- or polyisocyanates or mixtures thereof by linkage by means of urethane, allophanate, urea, biuret, uretdione, amide, isocyanurate, carbodiimide, uretonimine, oxadiazinetrione or iminooxadiazinedione structures can furthermore be used.

Di-, tri- or tetrafunctional compounds whose functional groups have different reactivities with respect to NCO groups are preferably used as compounds having at least two groups reactive with isocyanates.

Compounds having at least one primary and at least one secondary hydroxyl group, at least one hydroxyl group and at least one mercapto group, particularly preferably having at least one hydroxyl group and at least one amino group in the molecule, in particular amino alcohols, aminodiols and aminotriols, are preferred for the preparation of polyurethanes and polyureaurethanes, since the reactivity of the amino group is substantially higher than that of the hydroxyl group in the reaction with isocyanate.

Examples of said compounds having at least two groups reactive with isocyanates are propylene glycol, glycerol, mercaptoethanol, ethanolamine, N-methylethanolamine, diethanolamine, ethanolpropanolamine, dipropanolamine, diisopropanolamine, 2-amino-1,3-propanediol, 2-amino-2-methyl-1,3-propanediol or tris(hydroxymethyl)aminomethane. Mixtures of said compounds can furthermore be used.

The preparation of an ABx molecule for the preparation of a polyurethane from a diisocyanate and an aminodiol is explained here by way or example. First one mole of a diisocyanate is reacted with one mole of an aminodiol at low temperatures, preferably in the range of from −10 to 30° C. In this temperature range, virtually complete suppression of the urethane formation reaction takes place and the NCO groups of the isocyanate react exclusively with the amino group of the aminodiol. The ABx molecule formed, here an AB2 type, has a free NCO group and two free OH groups and can be used for the synthesis of hyperbranched polyurethane.

By heating and/or catalyst addition, this AB2 molecule can undergo an intermomlecular reaction to give a hyperbranched polyurethane. The synthesis of the hyperbranched polyurethane can advantageously be effected without prior isolation of the AB2 molecule in a further reaction step at elevated temperature, preferably in the range of from 30 to 80° C. The use of the AB2 molecule described, having two OH groups and one NCO group, results in the formation of a hyperbranched polymer which has one free NCO group and—depending on the degree of polymerization—a larger or smaller number of OH groups per molecule. The reaction can be carried out up to high conversions, with the result that very high molecular weight structures are obtained. However, it can also be stopped by adding suitable monofunctional compounds or by adding one of the starting compounds of the preparation of the AB2 molecule on reaching the desired molecular weight. Depending on the starting compound used for the stopping, other completely NCO-terminated or completely OH-terminated molecules form.

Alternatively, an AB2 molecule obtained from 1 mol of glycerol and 2 mol of 2,4-TDI can, for example, also be prepared. At low temperature, the primary alcohol groups and the isocyanate groups in the 4-position preferentially react, and an adduct which has an OH group and two isocyanate groups and which can be reacted as described at relatively high temperatures to give a hyperbranched polyurethane is formed. First, a hyperbranched polymer which has one free OH group and—depending on the degree of polymerization—a larger or smaller number of NCO groups forms.

Products which are reactive with urea or carbonate groups and have at least two amino groups in the molecule are preferably used for the preparation of polyureas according to WO 2005/044897 and WO 2005/075541.

These are, for example, ethylenediamine, N-alkylethylenediamine, propylenediamine, N-alkylpropylenediamine, hexamethylenediamine, N-alkylhexamethylenediamine, diaminodicyclohexylmethane, phenylenediamine, isophoronediamine, amine-terminated polyoxyalkylenepolyols (so-called Jeffamines), bis(aminoethyl)amine, bis(aminopropyl)amine, bis(aminohexyl)amine, tris(aminoethyl)amine, tris(aminopropyl)amine, tris(aminohexyl)amine, trisaminohexane, 4-aminomethyl-1,8-octamethylenediamine, N′-(3-aminopropyl)-N,N-dimethyl-1,3-propanediamine, trisaminononane or melamine. Furthermore, mixtures of said compounds may also be used.

The preparation of the hyperbranched polyurethanes and polyureas can be effected in principle without a solvent, but preferably in solution. All compounds which are liquid at the reaction temperature and inert to the monomers and polymers are in principle suitable as solvents.

Other products are obtainable by further synthesis variants. The following may be mentioned by way of example at this point:

AB3 molecules can be obtained, for example, by reacting diisocyanates with compounds having at least 4 groups reactive toward isocyanates. The reaction of toluylene diisocyanate with tris(hydroxymethyl)aminomethane may be mentioned by way of example.

For stopping the polymerization, polyfunctional compounds which can react with the respective A groups may also be used. In this way, a plurality of small hyperbranched molecules can be linked to give a larger hyperbranched molecule.

Hyperbranched polyurethanes and polyureas having extended branch chains can be obtained, for example, by using a diisocyanate and a compound which has two groups reactive with isocyanate groups, in the molar ratio 1:1, in addition to the ABx molecules. These additional AA or BB compounds may also have further functional groups which, however, are not permitted to be reactive toward the A or B groups under the reaction conditions. In this way, further functionalities can be introduced into the hyperbranched polymer.

Further suitable synthesis variants for hyperbranched polymers are to be found in DE-A 100 13 187 and DE-A 100 30 869.

The above-described hyperbranched polymers having urethane and/or urea groups can be used in general as such for modifying the surface properties of substrates. Their surface-modifying properties depend on the functional groups introduced with the synthesis.

The above-described hyperbranched polymers are preferably also subjected to a polymer-analogous reaction prior to their use for modifying substrate surfaces. Thus, the polymer properties can be adapted in a specific manner for the respective use, depending on the type and amount of the compounds used for the polymer-analogous reaction. Substrates as described above are therefore preferred, the hyperbranched polymer on the substrate surface being obtainable by polymer-analogous reaction of a hyperbranched polymer which carries urethane and/or urea groups and/or further functional groups which are capable of undergoing a condensation or an addition reaction with at least one compound which is selected from
a) compounds which carry at least one functional group complementary to the groups of the hyperbranched polymer which are capable of undergoing the condensation or addition reaction and additionally at least one hydrophilic group,
b) compounds which carry at least one functional group complementary to the groups of the hyperbranched polymer which are capable of undergoing the condensation or addition reaction and additionally at least one hydrophobic group
   and mixtures thereof.

In the context of the present invention, “complementary functional groups” are understood as meaning a pair of functional groups which can react with one another in a condensation or addition reaction. “Complementary compounds” are pairs of compounds which have functional groups complementary to one another.

Preferred complementary functional groups of the hyperbranched polymers and of the components a) and b) are selected from the complementary functional groups of the following overview.

| Hyperbranched polymer | Components a, b |
|---|---|
| —NCO | —OH, —NHR, —SH, COOH |
| —NH—C(═O)—O— | —NCO, —NHR, —OH |
| —NH—C(═O)—NR— | —NCO |
| —OH, —NHR, —SH | —NCO, —COOR′, |
| | —C(═O)—O—C(═O)—, epoxide |
| | —NH—C(═O)—O—, |
| | —O—C(═O)—CR═CRR′ |

R and R′ are preferably selected independently from hydrogen, alkyl, particularly preferably C1-C20-alkyl, such as methyl, ethyl, n-propyl, isopropyl, n-butyl, tert-butyl, the isomeric pentylene, hexylene, heptylene, octylene etc., cycloalkyl, particularly preferably C5-C8-cycloalkyl, such as cyclopentyl and cyclohexyl, aryl, particularly preferably phenyl, hetaryl, etc.

Preferred complementary compounds are, for example, firstly compounds having active hydrogen atoms which are selected, for example, from compounds having alcohol, primary and secondary amino and thiol groups and secondly compounds having groups reactive therewith, preferably isocyanate groups. As a rule, it is not critical which functional group carries the polymer component and which one carries compound a) and/or b).

Suitable hydrophilic groups of the compounds a) are selected from ionogenic, ionic and non-ionic hydrophilic groups. The ionogenic or ionic groups are preferably carboxyl groups and/or sulfo groups and/or nitrogen-containing groups (amines) or carboxylate groups and/or sulfonate groups and/or quaternized or protonated groups. Compounds a) which comprise acid groups may be partly or completely converted into the corresponding salts by neutralization. Suitable bases for the neutralization are, for example, alkali metal bases, such as sodium hydroxide solution, potassium hydroxide solution, sodium carbonate, sodium bicarbonate, potassium carbonate or potassium bicarbonate, and alkaline earth metal bases, such as calcium hydroxide, calcium oxide, magnesium hydroxide or magnesium carbonate, and ammonia and amines, such as trimethylamine, triethylamine, etc. Charged cationic groups can be produced from compounds a) having amine nitrogen atoms, either by protonation, for example with carboxylic acids, such as acetic acid, or by quaternization, for example, with alkylating agents, such as C1-C4-alkyl halides or sulfates. Examples of such alkylating agents are ethyl chloride, ethyl bromide, dimethyl sulfate and diethyl sulfate.

Hyperbranched polymers obtainable by polymer-analogous reaction and having ionic hydrophilic groups are as a rule water-soluble or water-dispersible.

Hydroxycarboxylic acids, such as hydroxyacetic acid (glycolic acid), hydroxypropionic acid (lactic acid), hydroxysuccinic acid (malic acid), hydroxypivalic acid, 4-hydroxybenzoic acid, 12-hydroxydodecanoic acid, dimethylolpropionic acid, dimethylolbutyric acid, etc., are preferably used as component a).

Hydroxysulfonic acids, such as hydroxymethanesulfonic acid or 2-hydroxyethanesulfonic acid, are furthermore preferably used as component a).

Mercaptocarboxylic acids, such as mercaptoacetic acid are furthermore preferably used as component a).

Aminosulfonic acids of the formula:

R¹HN—Y—SO₃H

where
Y is o-, m- or p-phenylene or straight-chain or branched C2-C6-alkylene which is optionally substituted by 1, 2 or 3, hydroxyl groups and
R1 is a hydrogen atom, a C1-C12-alkyl group (preferably C1-C10-alkyl group and in particular C1-C6-alkyl group) or a C5-C6-cycloalkyl group, it being possible for the alkyl group or the cycloalkyl group to be optionally substituted by 1, 2 or 3 hydroxyl groups, carboxyl groups or sulfo groups,
   are furthermore preferably used as component a).

The aminosulfonic acids of the above formula are preferably taurine, N-(1,1-dimethyl-2-hydroxyethyl)-3-amino-2-hydroxypropanesulfonic acid or 2-aminoethylaminoethane sulfonic acid.

a-, b- or g-amino acids, for example glycine, alanine, valine, leucine, isoleucine, phenylalanine, thyrosine, proline, hydroxyproline, serine, threonine, methionine, cysteine, tryptophan, b-alanine, aspartic acid or glutamic acid, are furthermore preferably used as component a).

Polyetherols are furthermore preferably used as component a). Suitable polyetherols are linear or branched substances which have terminal hydroxyl groups, comprise ether bonds and have a molecular weight in the range of, for example, from about 300 to 10 000. These include, for example, polyalkylene glycols, e.g. polyethylene glycols, polypropylene glycols, polytetrahydrofurans, copolymers of ethylene oxide, propylene oxide and/or butylene oxide which comprise the alkylene oxide units incorporated in the form of polymerized units in random distribution or in the form of blocks. α,ω-Diaminopolyethers which can be prepared by amination of polyetherols with ammonia are also suitable. Such compounds are commercially available under the name JeffamineR.

The component a) is furthermore preferably selected from diamines, polyamines and mixtures thereof.

Suitable amines a) are straight-chain or branched, aliphatic and cycloaliphatic amines having in general about 2 to 30, preferably about 2 to 20, carbon atoms. These include, for example, ethylenediamine, 1,2-diaminopropane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, diethylenetriamine, triethylenetetramine, 4-azaheptamethylene-diamine, N,N′-bis(3-aminopropyl)butane-1,4-diamine, and mixtures thereof. Suitable polyamines a) generally have a number-average molecular weight of from about 400 to 10 000, preferably from about 500 to 8000. These include, for example, polyamides having terminal, primary or secondary amino groups, polyalkylenamines, preferably polyethylenimines, and vinylamines obtained by hydrolysis of poly-N-vinylamides, such as, for example, poly-N-vinylacetamide.

The component a) is furthermore preferably selected from polyols. These include, for example, diols having 2 to 18 carbon atoms, preferably 2 to 10 carbon atoms, such as 1,2-ethanediol, 1,3-propanediol, 1,4-butanediol, 1,6-hexanediol, 1,5-pentanediol, 1,10-decanediol, 2-methyl-1,3-propanediol, 2-methyl-2-butyl-1,3-propanediol, 2,2-dimethyl-1,3-propanediol, 2,2-dimethyl-1,4-butanediol, 2-ethyl-2-butyl-1,3-propanediol, neopentylglycol hydroxypivalate, diethylene glycol and triethylene glycol. Suitable triols and polyols having a higher functionality are compounds having 3 to 25, preferably 3 to 18, particularly preferably 3 to 6 carbon atoms. Examples of triols which may be used are glycerol or trimethylolpropane. For example erythritol, pentaerythritol and sorbitol may be used as polyols having a higher functionality.

Amino alcohols are furthermore preferably used as component a). These preferably have 2 to 16, particularly preferably 3 to 12, carbon atoms, such as, for example, monoethanolamine, methylisopropanolamine, ethylisopropanolamine, methylethanolamine, 3-aminopropanol, 1-ethylaminobutan-2-ol, diethanolamine, dipropanolamine, dibutanolamine, tris(hydroxymethyl)aminomethane, tris(hydroxyethyl)aminomethane, 4-methyl-4-aminopentan-2-ol and N-(2-hydroxyethyl)aniline and mixtures thereof.

Suitable hydrophobic groups of compounds b) are selected from saturated or unsaturated hydrocarbon radicals having 8 to 40, preferably 9 to 35, in particular 10 to 30, carbon atoms. They are preferably alkyl, alkenyl, cycloalkyl or aryl radicals. The cycloalkyl or aryl radicals may have 1, 2 or 3 substituents, preferably alkyl or alkenyl substituents. In the context of the present invention, “alkenyl radicals” designate radicals which have one, two or more carbon-carbon double bonds.

In the context of the present invention, the expression C8-C40-alkyl comprises straight-chain or branched alkyl groups. These are preferably straight-chain or branched C9-C35-alkyl, particularly preferably C10-C30-alkyl and especially C12-C26-alkyl groups. They are preferably predominantly linear alkyl radicals as also occur in natural or synthetic fatty acids and fatty alcohols and oxo alcohols. These include, in particular, n-octyl, ethylhexyl, 1,1,3,3-tetramethylbutyl, n-nonyl, n-decyl, n-undecyl, n-dodecyl, n-tridecyl, myristyl, pentadecyl, palmityl (=cetyl), heptadecyl, octadecyl, nonadecyl, arachidyl, behenyl, lignocerenyl, cerotinyl, melissinyl, etc.

C8-C40-Alkenyl preferably represents straight-chain and branched alkenyl groups which may be mono-, di- or polyunsaturated. They are preferably C9-C35-alkenyl, in particular C10-C30-alkenyl and especially C12-C26-alkenyl groups. These include in particular octenyl, nonenyl, decenyl, undecenyl, dodecenyl, tridecenyl, tetradecenyl, pentadecenyl, hexadecenyl, heptadecenyl, octadecenyl, nonadecenyl, linolylyl, linolenylyl, elaostearylyl, etc. and in particular oleyl (9-octadecenyl).

The compound of the formula b) then preferably represents alkylamines, such as 1-octylamine, 1-nonylamine, 1-decylamine, 1-undecylamine, 1-undec-10-enylamine, 1-tridecylamine, 1-tetradecylamine, 1-pentadecylamine, 1-hexadecylamine, 1-heptadecylamine, 1-octadecylamine, 1-octadeca-9,12-dienylamine, 1-nonadecylamine, 1-eicosylamine, 1-eicos-9-enylamine, 1-heneicosylamine, 1-docosylamine and in particular oleylamine and 1-hexadecylamine (cetylamine), or amine mixtures prepared from naturally occurring fatty acids, such as, for example, tallow fatty amines which predominantly comprise saturated and unsaturated C14-, C16-C18-alkylamines or cocoamines which comprise saturated and mono- and diunsaturated C8-C22-alkylamines, preferably C12-C14-alkylamines.

The compound b) is furthermore preferably selected from monohydric alcohols which have one of the abovementioned hydrophobic radicals. Such alcohols and alcohol mixtures b) are obtainable, for example, by hydrogenation of fatty acids from natural fats and oils or of synthetic fatty acids, for example from the catalytic oxidation of paraffins. Suitable alcohols and alcohol mixtures b) are furthermore obtainable by hydroformylation of olefins with simultaneous hydrogenation of the aldehydes, in general mixtures of straight-chain and branched primary alcohols (oxo alcohols) resulting. Suitable alcohols and alcohol mixtures b) are furthermore obtainable by partial oxidation of n-paraffins by known processes, predominantly linear secondary alcohols being obtained. The substantially primary, straight-chain and branched Ziegler alcohols obtainable by organoaluminum synthesis are furthermore suitable.

Suitable monohydric alcohols b) are, for example, octanol, nonanol, decanol, undecanol, dodecanol, tridecanol, tetradecanol, pentadecanol, hexadecanol, heptadecanol, octadecanol, etc. and mixtures thereof.

Suitable monoisocyanates b) are, for example, C8-C40-alkyl isocyanates, which are obtainable from the abovementioned amines and amine mixtures by phosgenation or from natural or synthetic fatty acids and fatty acid mixtures by Hofmann, Curtius or Lossen degradation.

The abovementioned compounds a) and b) can in each case be used individually, as mixtures of exclusively hydrophilic compounds a) or of exclusively hydrophobic compounds b) and as mixtures of hydrophilic compounds a) with hydrophobic compounds b). By polymer-analogous reaction of hyperbranched polymers carrying urethane and/or urea groups with individual compounds a) or b) or with mixtures thereof, it is possible to vary the surface-modifying properties of the hyperbranched polymers in a wide range. It is thus possible to impart to the substrates modified with these polymers surface properties which range from a strong affinity to water and aqueous liquids (hydrophilicity) to a very low affinity to water and aqueous liquids (hydrophobicity).

Some further embodiments of polymer-analogous reaction are described below:

By reaction with compounds comprising acrylate groups, such as, for example, alcohols comprising acrylate groups, such as 2-hydroxyethylacrylate or 2-hydroxyethylmethacrylate, it is possible to obtain hyperbranched polyurethanes which have polymerizable olefinic groups and can be used for the preparation of radiation-curable, and in particular UV-crosslinking polymers. By reaction with appropriately substituted alcohols, it is also possible to introduce epoxide or vinyl ether groups which can be used for cationically crosslinking polymers.

Oxidatively drying hyperbranched polyurethanes or polyureas may be obtained by reacting polymers comprising NCO or urethane groups with mono- or polyunsaturated fatty acid esters which have at least one OH group or with mono- or polyunsaturated fatty alcohols or fatty amines, in particular having 3 to 40 carbon atoms. For example, OH group-comprising esters of linoleic acid, linolenic acid or elaeostearic acid can be reacted with NCO groups. However, NCO or urethane groups can furthermore be reacted directly with alcohols or amines comprising vinyl or allyl groups.

For the preparation of hyperbranched polyurethanes or polyureas which have different functionalities, for example, 2 mol of 2,4-TDI can be allowed to react with a mixture of 1 mol of trimethylolpropane and 1 mol of dimethylolpropionic acid. A product which has both carboxyl groups and OH groups is obtained here.

Furthermore, such products can also be obtained by effecting polymerization with an ABx molecule, stopping the polymerization at the desired degree of reaction and then reacting only some of the functional groups originally present, for example only some of the OH or of the NCO groups. For example, some of the NCO groups in an NCO-terminated polymer obtained from 2,4-TDI and glycerol can thus be reacted with ethanolamine and the remaining NCO groups with mercaptoacetic acid.

Furthermore, an OH-terminated polymer of isophorone diisocyanate and diethanolamine can be subsequently rendered hydrophobic by, for example, reacting some of the OH groups with dodecyl isocyanate or with dodecanoic acid. The refunctionalization of the hyperbranched polyurethane or the adaptation of the polymer properties to the application problem can advantageously be effected immediately after the polymerization reaction without isolating the NCO-terminated polyurethane beforehand. The functionalization can, however, also be effected in a separate reaction.

The hyperbranched polymers used according to the invention can be used in mixtures or in combination with further surface-active substances. These include customary anionic, nonionic or cationic surfactants or wetting agents. The hyperbranched polymers used according to the invention can, if desired, also be used in combination with further polymers, as are customary for the modification of the surface properties of substrates. By means of such a combination, it is possible in the initial case to achieve an enhancement of the surface-modifying effect.

In a preferred embodiment, the highly branched polyurethane, polyureaurethane or polyurea, preferably polyurethane, is used without further polymeric additives.

In a further preferred embodiment, the composition also comprises starch in addition to the polyurethane, polyureaurethane or polyurea.

In this context, starch is to be understood as meaning natural, modified or degraded starch. Natural starch may consist of amylose, amylopectin or mixtures thereof. Modified starch may be oxidized starch, starch esters or starch ethers. Anionic, cationic, amphoteric or nonionic modified starch is suitable.

The molecular weight of the starch can be reduced by hydrolysis (degraded starches). Suitable degradation products are oligosaccharides or dextrins.

The starch may originate from various sources and may be, for example, cereal, corn or potato starch, in particular, for example, starch from corn, waxy corn, rice, tapioca, wheat, barley or oats.

Potato starch or modified or degraded potato starch is preferred.

In particular, the composition comprises from 10 to 100 parts by weight, particularly preferably from 50 to 100% by weight, of polyurethane, polyureaurethane or polyurea and from 90 to 0 parts by weight, particularly preferably from 50 to 0% by weight, of starch, based on 100 parts by weight of the sum of polyurethane, polyureaurethane or polyurea and starch.

The composition may comprise further constituents, and suitable additives are described, for example, in WO 2004/092483; polyglyceryl esters may be mentioned by way of example.

The concomitant use of further additives is, however, not absolutely essential in the context of the present invention; in particular, no further additives are required for improved adhesion of the toner.

It is preferably an aqueous composition, in particular a composition in which the polyurethane, polyureaurethane or polyurea and, if appropriate, starch are dissolved or dispersed.

The composition can be applied by customary methods to the substrates to be printed on; methods in which the composition does not diffuse or scarcely diffuses into the substrate, for example, application using a film press, by spraying or by curtain coating, are preferred.

### Regarding the Process and the Substrates to be Printed on

The substrates pre-treated with the composition are preferably used for printing in an electrophotographic printing process.

An important feature of electrophotographic printing processes is that electrostatically charged dye systems, so-called toners, are used and an electrostatic charge image which can be developed in various ways is produced.

The electrostatic printing process designated as LEP (liquid electrostatic printing) or indigo printing process is particularly preferred.

An important feature of this printing process is the use of a liquid toner which is present as a liquid or as a viscous paste at room temperature (20° C.).

The temperature at which the toner is fixed on the substrate is relatively low in comparison with other electrostatic processes and is, for example, from 40 to 100° C.

The substrate to be printed on may be, for example, paper or polymer film.

It is preferably uncoated paper, i.e. base paper which is not coated with a paper coating slip, but other paper grades can also be treated therewith in order to improve the adhesion of the liquid toner.

In particular, the substrate to be printed on may also be wood-free paper.

The substrate to be printed on is pre-treated, in particular coated, with the composition (see above). The amount of the composition is preferably from 0.05 g/m² to 15 g/m² (solid), preferably from 0.1 g/m² to 5 g/m² (solid).

By using the pre-treated substrates, outstanding results are obtained in customary printing processes, but in particular in electrostatic processes and preferably in the LEP process. The adhesion of the toner on the substrate is very good and the printed image has a high quality.

### EXAMPLES

### Example 1

### Polyurea-Polyurethane Obtained from Hexamethylene Diisocyanate (HDI) and Diethanolamine (DEA)

672 g of HDI, dissolved in 672 g of dimethylacetamide (DMAc), were initially taken while blanketing with nitrogen and were cooled to 0° C. At this temperature, a solution of 422 g of diethanolamine in 422 g of DMAc was added in the course of 120 min with thorough stirring. After the addition the reaction solution was heated to 50° C. and the reduction in the NCO content was monitored titrimetrically. On reaching an NCO content of 3.4% by weight, cooling to 20° C. was effected, a further 162 g of diethanolamine, dissolved in 162 g of DMAc, were added and stirring was effected for a further 30 min. The reaction solution was then freed from the solvent on a rotary evaporator under reduced pressure. The polymer was analyzed by gel permeation chromatography using a refractometer as a detector. Dimethylacetamide was used as the mobile phase, and polymethyl methacrylate (PMMA) was used as a standard for determining the molecular weight. The molecular weight determination gave an Mn of 2550 Da and an Mw of 4200 Da.

### Example 2

### Polyureapolyurethane Obtained from Hexamethylene Diisocyanate (HDI) and Diisopropanolamine (DIIPA)

672 g of HDI, dissolved in 672 g of dry tetrahydrofuran (THF), were initially taken while blanketing with nitrogen and were cooled to 0° C. At this temperature, a solution of 532 g of DIIPA in 532 g of THF was added in the course of 60 min with thorough stirring. After the addition the reaction solution was heated to 50° C. and the reduction in the NCO content was monitored titrimetrically. On reaching an NCO content of 2.2% by weight, cooling to 20° C. was effected, a further 180 g of DIIPA, dissolved in 180 g of THF, were added and stirring was effected for a further 30 min. The reaction solution was then freed from the solvent on a rotary evaporator under reduced pressure. The analysis by gel permeation chromatography took place as described under example 1. The data were Mn=1250 Da, Mw=2600 Da.

### Example 3

### Polyurea Obtained from Urea and Diethylenetriamine

103 g of diethylentriamine and 1.4 g of potassium carbonate were initially taken in a three-necked flask equipped with a stirrer, reflux condenser and internal thermometer and were heated to 150° C. At this temperature, 60 g of urea, likewise heated to 150° C. were then added from a heatable feed vessel in the course of 30 min. The gas evolution started immediately after the beginning of the feed. After the end of the feed, the reaction mixture was stirred for a further 6 h at 150° C. and then cooled to room temperature.

The polyurea was analyzed by gel permeation chromatography using a refractometer as a detector. Hexafluoroisopropanol was used as the mobile phase and polymethyl methacrylate (PMMA) was used as a standard for determining the molecular weight. The molecular weight determination gave an Mn of 1800 Da and an Mw of 2400 Da.

### Example 4

### Polyurea Obtained from Diethyl Carbonate and Tris(Aminoethyl)Amine

450 g of tris(aminoethyl)amine, 363.9 g of diethyl carbonate and 0.2 g of dibutyltin dilaurate were initially taken in a three-necked flask equipped with a stirrer, reflux condenser and internal thermometer and the mixture was heated to 140° C. With progressive duration of the reaction the internal temperature of the reaction mixture decreased to about 110-120° C. owing to the resulting evaporative cooling of the ethanol liberated. After a duration of reaction of 4 h under reflux, the reflux condenser was exchanged for a descending condenser, ethanol was distilled off and the temperature was slowly increased to 170° C. After the end of the evolution of ethanol, the reaction mixture was cooled to room temperature. The molecular weight determination by gas permeation chromatography was effected as described in example 3. An Mn of 7300 Da and a Mw of 31 500 Da resulted.

Application of the starch/polymer mixtures:

An oxidatively degraded potato starch was heated to 95° C. for 30 minutes at a concentration of 20% in water according to the manufacturer's instructions. Thereafter, the starch solution was diluted to a solids content of 10% and cooled to about 60° C. Formulations were prepared from this starch solution and the polymers described in the examples, the solids content of the prepared formulation being adjusted to 10%. These mixtures were applied by means of a size press to a wood-free paper (basis weight 90 g/m²). Thereafter, the papers were dried by contact drying at 90° C. and then conditioned for 24 h at a relative humidity of 50% and a temperature of 24° C. The papers were then calendered (1 nip, 100 daN/cm).

The printing experiments were carried out on a Hewlett-Packard Indigo Digital printing machine 3000. The toner adhesion was carried out according to the tape pull method (DIN V EN V 12283) using a 3M #230 adhesive tape. For this purpose, the adhesive tape was stuck without bubbles onto the printed surface and then peeled off at constant speed at an angle of almost 180° C. The ink density of the print was determined by the pick test by means of a densitometer and stated as a value in the table of results. The determination of the toner adhesion or of the ink density according to the pick test was effected after certain time intervals (immediately/1 min/10 min/1 h/24 h).

| | Polymer | Amount | Amount by | | | | | |
|---|---|---|---|---|---|---|---|---|
| | from | by weight | weight of | Ink density | | | | |
| Example | example | of polymer | starch | immed. | 1 min | 10 min | 1 h | 24 h |
| 5 | — | 0 | 100 | 25 | 32 | 46 | 82 | 91 |
| 6 | 1 | 55 | 45 | 59 | 79 | 91 | 99 | 100 |
| 7 | 2 | 55 | 45 | 53 | 78 | 88 | 100 | 100 |
| 8 | 3 | 55 | 45 | 60 | 81 | 95 | 100 | 100 |
| 9 | 4 | 55 | 45 | 63 | 87 | 100 | 100 | 100 |
| 10 | 1 | 100 | 0 | 78 | 92 | 99 | 100 | 100 |
| 11 | 2 | 100 | 0 | 87 | 97 | 100 | 100 | 100 |
| 12 | 3 | 100 | 0 | 86 | 97 | 100 | 100 | 100 |
| 13 | 4 | 100 | 0 | 89 | 100 | 100 | 100 | 100 |

1. A process for printing on substrates, wherein the substrates are pre-treated with a composition which comprises a polyurethane, polyureaurethane or polyurea or a mixture thereof.

2. The process according to claim 1, wherein an at least partly branched polyurethane, polyureaurethane or polyurea or mixture thereof is employed.

3. The process according to claim 1, wherein the polyurethane, polyureaurethane or polyurea is obtainable by reacting isocyanate groups, urethane groups, urea groups or carbonate groups (referred to below as groups for short) with functional groups which are reactive with the respective groups (referred to below as “reactive groups” for short), the compounds used in the reaction being selected from those which comprise only groups (compound A), those which comprise only reactive groups (compound B), or those which comprise groups and reactive groups (compound C) and at least 1 mol % of the sum of groups and reactive groups being a constituent of at least trivalent compounds A), B) or C).

4. The process according to claim 1, wherein a highly branched or a dendritic polyurethane, a dendritic polyureaurethane or a dendritic polyurea is employed.

5. The process according to claim 1, wherein the composition may also comprise starch in addition to polyurethane, polyureaurethane or polyurea.

6. The process according to claim 1, wherein the composition comprises from 10 to 100 parts by weight of polyurethane, polyureaurethane or polyurea and from 0 to 90 parts by weight of starch, based on 100 parts by weight of the sum of polyurethane, polyureaurethane or polyurea and starch.

7. The process according to claim 1, wherein the composition is an aqueous solution or dispersion.

8. The process according to claim 1, wherein the printing process is an electrophotographic process.

9. The process according to claim 1, wherein the printing process is an LEP process (liquid electrophotographic printing).

10. The process according to claim 1, wherein the substrate to be printed on is paper or polymer film.

11. The process according to claim 1, wherein the substrate to be printed on is uncoated paper.

12. The process according to claim 1, wherein the substrate to be printed on is wood-free paper.

13. The process according to claim 1, wherein the substrate is coated or impregnated with the composition.

14. The process according to claim 1, wherein the substrate is coated or impregnated with from 0.05 g/m² to 15 g/m²of the composition (solid).

15. A printed substrate obtainable by the process according to claim 1.
